(19) United States
(12) Patent Application Publication
(10) Pub. No.: US 2025/0314742 A1
(43) Pub. Date: Oct. 9, 2025

(54) RADAR MEASURING DEVICE

(71) Applicant: VEGA Grieshaber KG, Wolfach (DE)

(72) Inventors: Winfried RAUER, Fischerbach (DE); Christoph MUELLER, Oppena (DE)

(73) Assignee: VEGA Grieshaber KG, Wolfach (DE)

(21) Appl. No.: 19/174,423

(22) Filed: Apr. 9, 2025

(30) Foreign Application Priority Data
Apr. 9, 2024 (DE) 10 2024 109 825.2

(51) Int. Cl. G01S 7/40; G01S 7/35; G01S 13/88

(52) U.S. Cl. CPC G01S 7/4013; G01S 7/35; G01S 13/88

(57) ABSTRACT

A radar measuring device for process automation in an industrial or private environment, with control circuitry for calculating an average transmission power of a radar measuring signal to be emitted during a measuring interval and for dividing the measuring interval into several successive partial measuring intervals when the calculated average transmission power is greater than the preset threshold power.

### CROSS-REFERENCE TO RELATED APPLICATIONS

This application claims the benefit of the filing date of German Patent Application No. 10 2024 109 825.2 filed on 9 Apr. 2024, the entire content of which is incorporated herein by reference.

### TECHNICAL FIELD

The present disclosure relates to process automation in an industrial or private environment. In particular, the present disclosure relates to a radar measuring device for process automation in an industrial or private environment, a use of such a radar measuring device, a method for measuring with a radar measuring device, a program element and a computer-readable medium.

### BACKGROUND

In the case of radar measuring devices for process automation in industrial or private environments, particularly in level measurement technology, but also in production automation, care should be taken to ensure that the average RF transmitting power emitted by the radar measuring device does not exceed a specified threshold power. In particular, the average radiated transmission power emitted during a measurement interval of the radar measuring device can be decisive for this.

To adjust the transmission power, the user can reduce it depending on where the radar measuring device is being used.

### SUMMARY

There may be a desire to provide a radar measuring device which does not exceed a maximum predetermined transmission power on average over time.

This desire is met by the features of the independent patent claims. Further embodiments of the present disclosure result from the subclaims and the following description of embodiments.

A first aspect of the present disclosure relates to a radar measuring device configured for process automation in an industrial or private environment. In particular, the radar measuring device has a control unit which is configured to calculate an average transmission power of a radar measurement signal to be emitted during a measurement interval.

The control unit is configured to compare the calculated average transmission power with a preset threshold power and then divide the measurement interval into several successive partial measurement intervals (partial sweeps) if the calculated average transmission power is greater than the preset threshold power.

The successive partial measurement intervals are separated from each other by a measurement pause in order to reduce the average transmission power of the radar measurement signal to be emitted so that it falls below the preset threshold value.

The term “measurement interval” can be understood as a time interval during which a measurement cycle is carried out, for example in the form of a frequency sweep or frequency sweep in the case of an FMCW radar measuring device (FMCW: Frequency Modulated Continuous Wave). In the case of a pulse radar measurement signal, the measurement interval therefore corresponds to the time interval during which a radar pulse is transmitted (and received again).

Once the measuring interval has been completed, an echo curve has been recorded, which can be used to calculate a fill level, for example.

The (calculated) average transmission power corresponds to the average radiated transmission power of the radar measurement signal in this measurement interval.

In other words, a measurement is broken down into several partial measurements, which can then be reassembled into a complete full measurement using software.

The division of the measurement interval into several successive partial measurement intervals or partial sweeps can depend on national requirements (which can be determined independently by the radar measuring device using GPS and/or country input, possibly via a database query in the cloud or stored data in the radar measuring device), the radar measuring device can be set up to do this independently and to determine the partial measurement intervals itself. An AI can be provided for this purpose.

It may be provided that the radar measuring device is connected to a 4.20 mA supply (“loop”). In particular, it may be provided that the radar measuring device is supplied exclusively from this loop.

In particular, the radar measuring device can also be designed as a battery-operated sensor. In this case, the valid radio approval may also require the described procedure with sweep splitting.

According to one embodiment of the present disclosure, the radar measurement device comprises a radar module adapted to generate and radiate the radar measurement signal during the successive partial measurement intervals.

In particular, the radar measuring device can be designed as an FMCW radar measuring device.

With FMCW radar measuring devices, it is often not possible or only possible with considerable effort to carry out a frequency sweep (frequency sweep) due to the maximum possible sampling rates of the analog-to-digital converter, occurring IF (intermediate frequency) frequencies or maximum realizable ramp units so short that the regulations of the maximum permissible average transmission power are still fulfilled even with the maximum possible transmission power.

However, as described above, the frequency sweep can also be carried out in such a way that the requirements for the maximum permitted transmitted average RF transmit power are met. Depending on the maximum possible transmission power of the radar measurement signal to be emitted, the average power is reduced accordingly using suitable measures (mitigation techniques).

This is done by dividing the frequency sweep into several short sections (partial sweeps or partial measurement intervals), which can then be reassembled into a complete sweep using software.

According to an embodiment, the control unit is configured to determine the number of partial measurement intervals as a function of the size of the frequency deviation of the entire frequency sweep of the measurement interval and/or as a function of the maximum transmission power of the radar measurement signal to be emitted when the measurement interval is divided into several successive partial measurement intervals.

According to a further embodiment of the present disclosure, the control unit is configured to determine the length of the measurement pause between successive partial measurement intervals as a function of the size of the frequency deviation of the entire frequency sweep of the measurement interval and/or as a function of the maximum transmission power of the radar measurement signal to be emitted when the measurement interval is divided into a plurality of successive partial measurement intervals.

According to a further embodiment of the present disclosure, the control unit is configured to reduce the increase in the frequency ramp of the frequency sweep when the measurement interval is divided into a plurality of successive partial measurement intervals.

Depending on the size of the frequency deviation, it can be divided into different numbers of partial sweeps in order to meet the requirements for the maximum possible average RF output power with a corresponding pause between the partial sweeps.

An advantage of such a method may be that the partial sweeps can also be performed with a lower ramp steepness. This means that radar systems with relatively slow AD converters, a high number of points (i.e., a high number of samples) and therefore long sweep times can also be realized.

Another advantage may be that the required energy storage (e.g., storage capacitor) in the radar measuring device can be smaller for short sweeps or partial sweeps.

The sweep division into several consecutive partial measurement intervals also has advantages in terms of power management as a whole, as the load jumps are smaller or shorter and can be controlled or reacted to more precisely.

According to a further embodiment of the present disclosure, the radar measurement device is designed such that no radar measurement signal is emitted during the measurement pauses between the successive partial measurement intervals.

According to a further embodiment of the present disclosure, the control unit is arranged to run through the frequency sweep faster and simultaneously increase the sampling frequency of the radar measurement signal if the calculated average transmission power is greater than the preset threshold power.

In order to reduce the average transmission power, several precautions can therefore be taken; on the one hand, the measurement interval can be divided into successive partial measurement intervals, which are separated in time by corresponding measurement pauses, and on the other hand, the frequency ramp can be passed through more quickly while at the same time increasing the sampling frequency of the radar measurement signal.

According to a further embodiment of the present disclosure, the maximum transmission power of the radar measurement signal to be emitted is not changed even if the measurement interval is divided into several successive partial measurement intervals.

The “maximum transmission power of the radar measurement signal to be emitted” is the maximum value of the transmission power to be emitted. Ideally, the transmit power does not fluctuate along the frequency ramp. With many radar circuits, however, it is possible to influence the output power via a controllable amplifier. Depending on the application, the antenna used or the radio approval standard, the total transmission power can be set (to the same value over the entire frequency ramp).

A further aspect of the present disclosure relates to the use of a radar measuring device described above and below for level measurement or object detection, for example when monitoring a work area.

A further aspect of the present disclosure relates to a method for measuring with a radar measuring device for process automation in an industrial or private environment. First, the average transmission power of a radar measurement signal to be emitted during a measurement interval is calculated, whereupon the calculated average transmission power is compared with a preset threshold power. If the calculated average transmission power is greater than the preset threshold power, the measurement interval is divided into two or more successive partial measurement intervals, each separated by a measurement pause, in order to reduce the average transmission power of the radar measurement signal to be emitted so that it falls below the preset threshold value.

Another aspect of the present disclosure relates to a program element which, when executed on a control unit of a radar measuring device, instructs the radar measuring device to perform the steps described above and below.

Another aspect of the present disclosure relates to a computer-readable medium on which a program element described above is stored.

The term “process automation in an industrial environment” can be understood as a branch of technology that includes measures for the operation of machines and systems without the involvement of humans. One aim of process automation is to automate the interaction of individual components of a plant in the chemical, food, pharmaceutical, petroleum, paper, cement, shipping or mining industries. A variety of sensors can be used for this purpose, which are adapted in particular to the specific requirements of the process industry, such as mechanical stability, insensitivity to contamination, extreme temperatures and extreme pressures. Measured values from these sensors are usually transmitted to a control room, where process parameters such as fill level, limit level, flow rate, pressure or density can be monitored and settings for the entire plant can be changed manually or automatically.

An area of process automation in the industrial environment concerns the logistics automation of systems and the logistics automation of supply chains. Distance and angle sensors are used in logistics automation to automate processes inside or outside a building or within an individual logistics system. Typical applications for logistics automation systems include baggage and freight handling at airports, traffic monitoring (toll systems), retail, parcel distribution and building security (access control). What the examples listed above have in common is that presence detection in combination with precise measurement of the size and position of an object is required by the respective application. Sensors based on optical measurement methods using lasers, LEDs, 2D cameras or 3D cameras, which detect distances according to the time-of-flight (ToF) principle, can be used for this purpose.

Another area of process automation in the industrial environment is factory/production automation. Applications for this can be found in a wide variety of sectors such as automotive manufacturing, food production, the pharmaceutical industry or in the packaging sector in general. The aim of factory automation is to automate the production of goods using machines, production lines and/or robots, i.e., to run them without human intervention. The sensors used here and the specific requirements in terms of measuring accuracy when detecting the position and size of an object are comparable to those in the previous example of logistics automation.

The terms used in the claims should be construed so as to give them the broadest reasonable interpretation consistent with the foregoing description. For example, the use of the article “a” or “the” when introducing an element should not be construed to exclude a plurality of elements. Similarly, the mention of “or” should be construed to include a plurality of elements, so that the mention of “A or B” does not exclude “A and B” unless it is clear from the context or the preceding description that only one of A and B is meant. Furthermore, the phrase “at least one of A, B and C” should be understood as one or more elements from a group of elements consisting of A, B and C, and should not be interpreted as requiring at least one of each of the listed elements A, B and C, regardless of whether A, B and C are linked as categories or otherwise. Furthermore, the mention of “A, B and/or C” or “at least one of A, B or C” should be construed to include any single unit of the listed elements, e.g., A, any subset of the listed elements, e.g., A and B, or the entire list of elements A, B and C.

Further embodiments of the present disclosure are described below with reference to the figures. The illustrations in the figures are schematic and not to scale. If the same reference signs are used in the following description of the figures, these designate the same or similar elements.

### BRIEF DESCRIPTION OF THE FIGURES

FIG. 1 shows a frequency sweep that is divided into several partial frequency sweeps.

FIG. 2 shows another example of such a division.

FIG. 3 shows another example of such a division.

FIG. 4 shows a radar measuring device according to an embodiment of the present disclosure.

FIG. 5 shows a flowchart of a method according to one embodiment of the present disclosure.

### DETAILED DESCRIPTION OF EMBODIMENTS

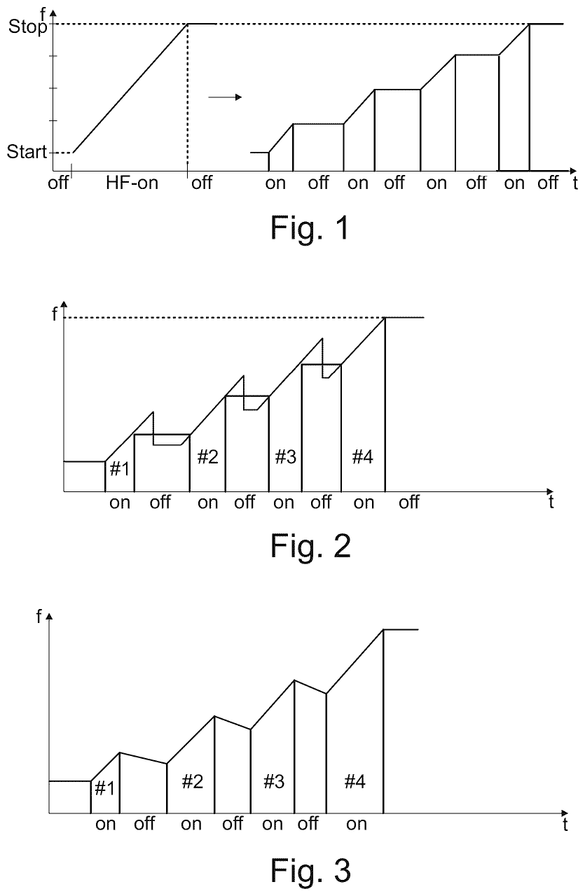

FIG. 1 shows a frequency sweep on the left-hand side, which shows the frequency of the radar measurement signal to be emitted by a radar measurement device as a function of time.

In the so-called off range, no radar measurement signal is present at the antenna of the radar measurement signal. In the subsequent RF ON range, the measurement starts and the radar measurement signal to be emitted is increased linearly over time from a start frequency to a stop frequency. In this context, one also speaks of a so-called frequency ramp that is run through. At the end of the frequency ramp, the frequency sweep stops, and an off-phase begins again, during which no signal is emitted by the antenna.

The right-hand section of FIG. 1 now shows how this frequency ramp can be divided into several partial frequency ramps or partial measurement intervals, each of which is separated from the others by an off-phase. During these off-phases, also called measurement pauses, no radar measurement signal is emitted.

In other words, the frequency sweep is divided into several partial sweeps. For example, an 8 GHz sweep with a sweep time of 2 ms is divided into four partial sweeps. A partial sweep is therefore 0.5 ms long, followed by a 0.5 ms pause. The entire bandwidth is thus realized in 4 ms.

The number of partial measurement intervals (partial sweeps) is between 2 and 10 partial measurement intervals, for example. However, more partial measurement intervals can also be provided, which can lead to shorter measurement pauses between the adjacent partial measurement intervals. The measurement intervals can be of the same length or of different lengths. In FIG. 1, these are also not drawn with the same length.

It may be intended that the partial sweeps overlap each other, for example to reduce transient effects. The software must then be aware of the overlapping points and leave them out when joining them together. This is shown in FIGS. 2 and 3.

Different procedures are possible in these cases: The controlling phase-locked loop (PLL) always remains active or is switched off completely in the meantime. If overlapping partial sweeps are realized, the PLL can also approach the new start frequency in a downward ramp and then continue the sweep again. This is shown in FIG. 3. This means that the “start-up time” of the PLL, i.e., the startup phase and the adjustment phase to the start frequency, can be omitted or shortened. In addition, the subsequent VCO does not remain at one frequency, which could lead to interference within the device.

As a rule, a VCO is always connected downstream of the PLL. This can also be switched off or remain active during the measurement sweep pauses. A variety of realization forms are also possible here.

There are therefore many possible and planned designs. It is important that the RF transmission signals do not reach the antenna during the “off phases” (measurement pauses) so that no radar measurement signal is emitted.

If several different frequency sweeps/bandwidths are realized in a radar measuring device, the division into several partial sweeps can also be variable. This means that the software can be set up to decide how many partial sweeps are to be realized depending on the set frequency deviation.

This automated procedure can also be used depending on the applicable radio approval (country dependency). If the limit value is high enough, it may be possible to measure in a sweep; otherwise it must be split. The actual transmitted power can also be monitored here, for example using a power detector. This measured value can be used as an input variable for the automated procedure.

The frequency can also be minimized during the pause times (=start frequency of the first partial sweep or frequency of the following VCO with tuning voltage=0 V). In general, the frequency in the transmission pauses can be fixed or variable (fixed or free) and a mixture of sweep splitting and reduction of the transmission power can also be realized. In particular, a combination is possible depending on the application, radio approval and available maximum RF transmission power. A sweep interruption before the maximum possible average transmission power is reached can be the declared objective. In this case, a “safety distance” can also be provided.

In other words, the control unit can be set up in particular to continuously calculate the average transmission power that has already been emitted and to interrupt the frequency sweep in good time before the maximum permissible average transmission power is reached by inserting a measurement pause.

A sweep division can also be provided for energy reasons, for example if the energy of the sensor is or becomes scarce. In this consideration, it must be taken into account that the required energy storage in the radar measuring device can be selected smaller for short sweeps (or partial sweeps).

Sweep splitting may also be necessary if the PLL and/or the downstream VCO cannot generate ramps as quickly as would be necessary. If the system has to be “slowed down” for such reasons, large frequency ramps (large radar bandwidth) can only be realized with long sweep times, which may not be compatible in terms of energy or radio approval.

In this context, it should be noted that in the present disclosure the terms partial sweep and partial measurement interval correspond to each other.

The sampling frequency can also be taken into account in the automated measurement process. This means that the frequency ramp can be realized faster or shorter if required; the sampling rate can also be increased if possible, thereby maintaining the same number of sampling points. This variant is particularly possible if the analog-to-digital converter can convert fast enough.

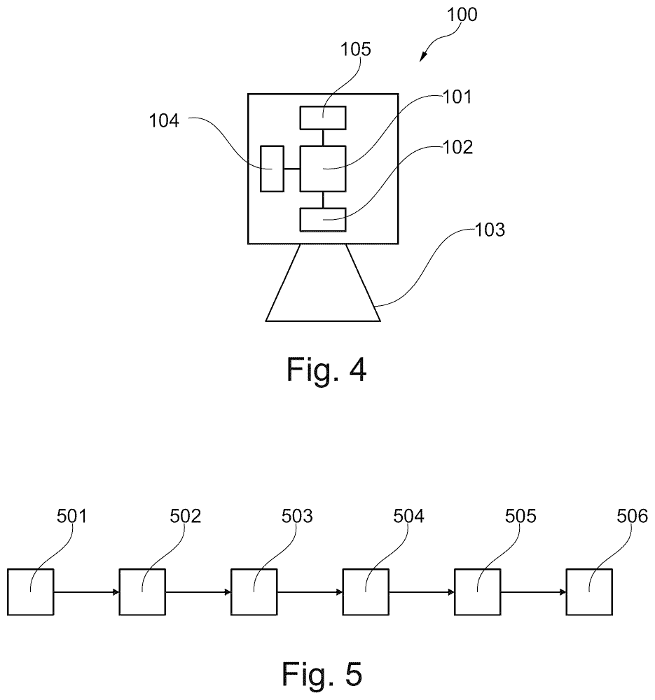

FIG. 4 shows a radar measuring device 100 according to an embodiment of the present disclosure. The radar measuring device 100 is designed as an FMCW level radar measuring device and, in addition to the control unit 101 and the radar module 102, has an antenna 103 which emits the radar measuring signal and receives the reflected radar measuring signal again.

In addition, the radar measuring device 100 has a power detector 104 and a data memory 105. The phase-locked loop (PLL) is part of the control unit 101 or the radar module 102.

FIG. 5 shows a flowchart of a method according to an embodiment of the present disclosure. In step 501, an average transmission power of a radar measurement signal to be emitted during a measurement interval is calculated. In step 502, the calculated average transmission power is compared with a preset threshold power and in step 503, the measurement interval is divided into a plurality of successive partial measurement intervals since the calculated average transmission power is greater than the preset threshold power. In step 504, the successive partial measurement intervals are each separated from one another by a measurement pause in order to reduce the average transmission power of the radar measurement signal to be emitted so that it falls below the preset threshold value. In step 505, the radar measurement signal is radiated during the successive partial measurement intervals. The radar signals emitted are reflected at the product surface, for example, and received again by the antenna of the radar measuring device in step 506 and “assembled” by the control unit in order to calculate the fill level.

In addition to dividing the measurement interval into partial measurement intervals and inserting measurement pauses in between, the sweep time can also be reduced overall.

This results in a reduced number of sampling points at the same sampling rate. The frequency deviation or bandwidth can also be reduced. The overall transmission power can also be reduced. As already described above, the slope of the frequency ramps can also be increased in order to reduce the measurement time, while at the same time increasing the measurement pauses between the partial measurement intervals.

1. A radar measuring device for process automation in an industrial or private environment, the radar measuring device comprising:
control circuitry configured to calculate an average transmission power of a radar measurement signal to be emitted during a measurement interval,
wherein the control circuitry is further configured to compare the calculated average transmission power with a preset threshold power and to divide the measurement interval into several successive partial measurement intervals when the calculated average transmission power is greater than the preset threshold power, and
wherein the successive partial measurement intervals are separated from each other by a measurement pause in order to reduce the average transmission power of the radar measurement signal to be emitted so that the average transmission power falls below a preset threshold value.

2. The radar measuring device according to claim 1, further comprising:
a radar module configured to generate and radiate the radar measurement signal during the successive partial measurement intervals.

3. The radar measuring device according to claim 1,
wherein the radar measuring device is an FMCW radar measuring device.

4. The radar measuring device according to claim 3,
wherein the control circuitry is further configured to determine a number of partial measurement intervals as a function of a size of a frequency deviation of an entire frequency sweep of the measurement interval and/or as a function of a maximum transmission power of the radar measurement signal to be emitted when the measurement interval is divided into a plurality of successive partial measurement intervals.

5. The radar measuring device according to claim 3,
wherein the control circuitry is further configured to determine a length of the measurement pause between two successive partial measurement intervals as a function of a size of a frequency deviation of an entire frequency sweep of the measurement interval and/or as a function of a maximum transmission power of the radar measurement signal to be emitted, when the measurement interval is divided into a plurality of successive partial measurement intervals.

6. The radar measuring device according to claim 3,
wherein the control circuitry is further is configured to reduce a slope of a frequency ramp of a frequency sweep when the measurement interval is divided into several successive partial measurement intervals.

7. The radar measuring device according to claim 1,
wherein the control circuitry is further configured to prevent that a radar measurement signal is emitted during the measurement pauses between the successive partial measurement intervals.

8. The radar measuring device according to claim 3,
wherein the control circuitry is further configured to run through a frequency sweep faster and simultaneously increase a sampling frequency of the radar measurement signal when the calculated average transmission power is greater than the preset threshold power.

9. The radar measuring device according to claim 1,
wherein a maximum transmission power of the radar measurement signal to be emitted is not changed, even when the measurement interval is divided into several consecutive partial measurement intervals.

10. The radar measuring device according to claim 4,
wherein the control circuitry is further configured to determine a length of the measurement pause between two successive partial measurement intervals as a function of a size of a frequency deviation of an entire frequency sweep of the measurement interval and/or as a function of a maximum transmission power of the radar measurement signal to be emitted, when the measurement interval is divided into a plurality of successive partial measurement intervals.

11. The radar measuring device according to claim 4,
wherein the control circuitry is further is configured to reduce a slope of a frequency ramp of the frequency sweep when the measurement interval is divided into several successive partial measurement intervals.

12. The radar measuring device according to claim 5,
wherein the control circuitry is further is configured to reduce a slope of a frequency ramp of the frequency sweep when the measurement interval is divided into several successive partial measurement intervals.

13. The radar measuring device according to claim 2,
wherein the radar measuring device is an FMCW radar measuring device.

14. The radar measuring device according to claim 4,
wherein the control circuitry is further configured to run through the frequency sweep faster and simultaneously increase a sampling frequency of the radar measurement signal when the calculated average transmission power is greater than the preset threshold power.

15. The radar measuring device according to claim 5,
wherein the control circuitry is further configured to run through the frequency sweep faster and simultaneously increase a sampling frequency of the radar measurement signal when the calculated average transmission power is greater than the preset threshold power.

16. The radar measuring device according to claim 6,
wherein the control circuitry is further configured to run through a frequency sweep faster and simultaneously increase a sampling frequency of the radar measurement signal when the calculated average transmission power is greater than the preset threshold power.

17. The radar measuring device according to claim 7,
wherein the control circuitry is further configured to run through a frequency sweep faster and simultaneously increase a sampling frequency of the radar measurement signal when the calculated average transmission power is greater than the preset threshold power.

18. A method of measuring with a radar measuring device for process automation in an industrial or private environment, comprising:
calculating, using control circuitry, an average transmission power of a radar measurement signal to be emitted during a measurement interval;
comparing the calculated average transmission power with a preset threshold power; and
splitting the measurement interval into several consecutive partial measurement intervals when the calculated average transmission power is greater than the preset threshold power,
wherein the successive partial measurement intervals are separated from each other by a measurement pause in order to reduce the average transmission power of the radar measurement signal to be emitted so that it falls below a preset threshold value.

19. A non-transitory computer-readable medium on which a program is stored that when executed by processing circuitry causes the processing circuitry to implement a method of measuring with a radar measuring device for process automation in an industrial or private environment, comprising:
calculating, using control circuitry, an average transmission power of a radar measurement signal to be emitted during a measurement interval;
comparing the calculated average transmission power with a preset threshold power; and
splitting the measurement interval into several consecutive partial measurement intervals when the calculated average transmission power is greater than the preset threshold power,
wherein the successive partial measurement intervals are separated from each other by a measurement pause in order to reduce the average transmission power of the radar measurement signal to be emitted so that it falls below a preset threshold value.
